(19) United States
(12) Patent Application Publication
(10) Pub. No.: US 2015/0220178 A1
(43) Pub. Date: Aug. 6, 2015

(54) MULTITOUCH TOOLS FOR USE WITH A CAPACITIVE TOUCH SENSOR

(71) Applicants: Zachary Joseph Zeliff, Taipei (TW); Kristopher Perpich, Austin, TX (US); San-Hsu Chao, Taipei (TW); Peiter Buick, Austin, TX (US); Stan Lan, Taipei (TW); David Lee, Taipei (TW)

(72) Inventors: Zachary Joseph Zeliff, Taipei (TW); Kristopher Perpich, Austin, TX (US); San-Hsu Chao, Taipei (TW); Peiter Buick, Austin, TX (US); Stan Lan, Taipei (TW); David Lee, Taipei (TW)

(21) Appl. No.: 14/588,884

(22) Filed: Jan. 2, 2015

Related U.S. Application Data
(60) Provisional application No. 61/922,868, filed on Jan. 2, 2014.

(51) Int. Cl. G06F 3/044

(52) U.S. Cl. CPC G06F 3/044; G06F 2203/04104

(57) ABSTRACT

Embodiments of a multitouch tool for capacitive touchscreens are disclosed. The multitouch tools have a plurality of conductive posts configured to interact with a capacitive touchscreen of an electronic device such that the touchscreen can determine an orientation of the tool. The tools further have a window through which the touchscreen can display an on-screen control. The user can touch the screen either outside the tool's perimeter or through the window in the tool, or both, to interact with on-screen controls that are generated in response to the electronic device detecting and recognizing the pattern of touches generated by the tool.

### CROSS REFERENCE TO RELATED APPLICATIONS

This application claims the benefit of U.S. provisional patent application Ser. No. 61/922,868, filed on Jan. 2, 2014, which is hereby incorporated by reference in its entirety for all purposes.

### FIELD

This disclosure relates to tools for use with a capacitive touchscreen or touchpad, and more specifically to tools that interact with a capacitive touchscreen or touchpad using multiple contacts.

### SUMMARY OF THE PRIOR ART

Electronic devices that use capacitive touchscreens or touchpads, such as tablet computers and smartphones, have become increasingly popular in the last decade. User interactions with capacitive touchscreens take advantage of the ability of capacitive touchscreens to detect multiple points of contact at any given moment. Interface designers have come up with such user interactions as pinching (two touches at the same time, moving closer), tapping (a single touch, starting and stopping quickly), crumpling (three to five touches, moving closer together), and sliding (a single touch, moving from an initial point to a subsequent point).

Users have also embraced the use of styluses for interacting with capacitive touchscreens. Styluses offer several advantages over the use of fingers, such as increased accuracy, reduced obstruction of the screen, and avoidance of smearing the touchscreen surface with oils and dirt. Users also find the use of a tool to be convenient, familiar, and more traditional than using their fingers. However, styluses typically have only a single point of contact, requiring users to resort to using one or more fingers, with or without a stylus, when a multitouch gesture is necessary.

Improvements in the field of styluses are thus desirable.

### SUMMARY OF CERTAIN ASPECTS OF THE EMBODIMENTS

Embodiments are disclosed that use multiple contacts in a fixed arrangement to create distinctive touch patterns to interact with a capacitive touchscreen. Some embodiments have touch patterns that indicate an orientation to software running on the electronic device. Some embodiments have a shape indicating an orientation to the user. Some embodiments have a window or windows through which the display may interact with the user, and through which the user may further interact with the capacitive touchscreen. Some embodiments have an auxiliary contact that the user may touch to further interact with the capacitive touchscreen. Some embodiments have a combination of some or all of the aforementioned features.

### BRIEF DESCRIPTION OF THE DRAWINGS

FIG. 1 is a top view of an embodiment of a multitouch tool;

FIG. 2 is a side view of an embodiment of a multitouch tool;

FIG. 3 is a bottom view of an embodiment of a multitouch tool;

FIG. 4 is a side view of a conductive component of an embodiment of a multitouch tool;

FIG. 5 is a perspective view of a conductive component of an embodiment of a multitouch tool;

FIG. 6 is a perspective view of a nonconductive component of an embodiment of a multitouch tool;

FIG. 7 is a top view of an embodiment of a multitouch tool;

FIG. 8 is a side view of an embodiment of a multitouch tool;

FIG. 9 is a bottom view of an embodiment of a multitouch tool;

FIG. 10 is a side view of a conductive component of an embodiment of a multitouch tool;

FIG. 11 is a perspective view of a conductive component of an embodiment of a multitouch tool;

FIG. 12 is a perspective view of a nonconductive component of an embodiment of a multitouch tool;

FIG. 13 is a top view of an embodiment of a multitouch tool;

FIG. 14 is a bottom view of an embodiment of a multitouch tool;

FIG. 15 is a perspective view from below of an embodiment of a multitouch tool;

FIG. 16 is an exploded perspective view from below of an embodiment of a multitouch tool;

FIG. 17 is a perspective view from above of a nonconductive component of an embodiment of a multitouch tool;

FIG. 18 is a side view of an embodiment of a multitouch tool;

FIG. 19 is a cross section view of a conductive body of an embodiment of a multitouch tool along the line A-A of FIG. 14;

FIG. 20 is a cross section view of an embodiment of a nonconductive component for an embodiment of a multitouch tool along the line A-A of FIG. 14;

FIG. 21 is a cross section view of an embodiment of a nonconductive component for an embodiment of a multitouch tool along the line A-A of FIG. 14;

FIG. 22 is a perspective view of an embodiment of a conductive center component for an embodiment of a multitouch tool;

FIG. 23 is a perspective view of an embodiment of a monolithic conductive center component for an embodiment of a multitouch tool;

FIG. 24 is a plan view of conductive regions and traces on a substrate for an embodiment of a multitouch tool;

FIG. 25 is a side view of a substrate wrapped around a nonconductive body to form an embodiment of a multitouch tool;

FIG. 26 is an exploded top view of a nonconductive body and an end cap for an embodiment of a multitouch tool;

FIG. 27 is a top view of an assembled embodiment of a multitouch tool;

FIG. 28 is a plan view of conductive regions and traces on a portion of a substrate for an embodiment of a multitouch tool;

FIG. 29 is a plan view of conductive regions and traces on a substrate for an embodiment of a multitouch tool;

FIG. 30 is a top view of a nonconductive body for another embodiment of a multitouch tool;

FIG. 31 is a top view of an assembled embodiment of a multitouch tool;

FIG. 32 is a view of either of the embodiments of FIG. 1 through FIG. 6 or FIG. 7 through FIG. 12 in use on a touchscreen device;

FIG. 33 is a view of the embodiment of FIG. 13 through FIG. 23 in use on a touchscreen device;

FIG. 34 is a top view of an embodiment of a nonconductive component of a multitouch tool;

FIG. 35 is a top view of an embodiment of a multitouch tool where the window in the nonconductive layer is noncongruent to the window in the conductive layer;

FIG. 36 is a bottom view of an embodiment of a multitouch tool; and

FIG. 37 is a bottom view of an embodiment of a multitouch tool.

### DETAILED DESCRIPTION OF THE EMBODIMENTS

The following detailed description of embodiments references the accompanying drawings that form a part hereof, and in which are shown by way of illustration various illustrative embodiments through which the invention may be practiced. The embodiments are described in sufficient detail to enable those skilled in the art to practice the invention, and it is to be understood that other embodiments may be utilized and that logical changes may be made without departing from the spirit and scope of the invention. The detailed description is, therefore, not to be taken in a limiting sense, and the scope of the invention is defined solely by the appended claims.

As used herein, a “touch pattern” is the pattern of capacitive touches induced by an object touching a capacitive touchscreen, including the size or sizes of the touches, the shape or shapes of the touches, and (where involving multiple touches) the relative positions of the touches. A fingertip typically induces a single ovoid touch; a stylus tipped with a silicone blob typically induces a single ovoid touch; a stylus tipped with a solid tip typically induces a single touch in the shape of the tip. Multitouch gestures generally involve multiple fingertips, usually meant to occur simultaneously.

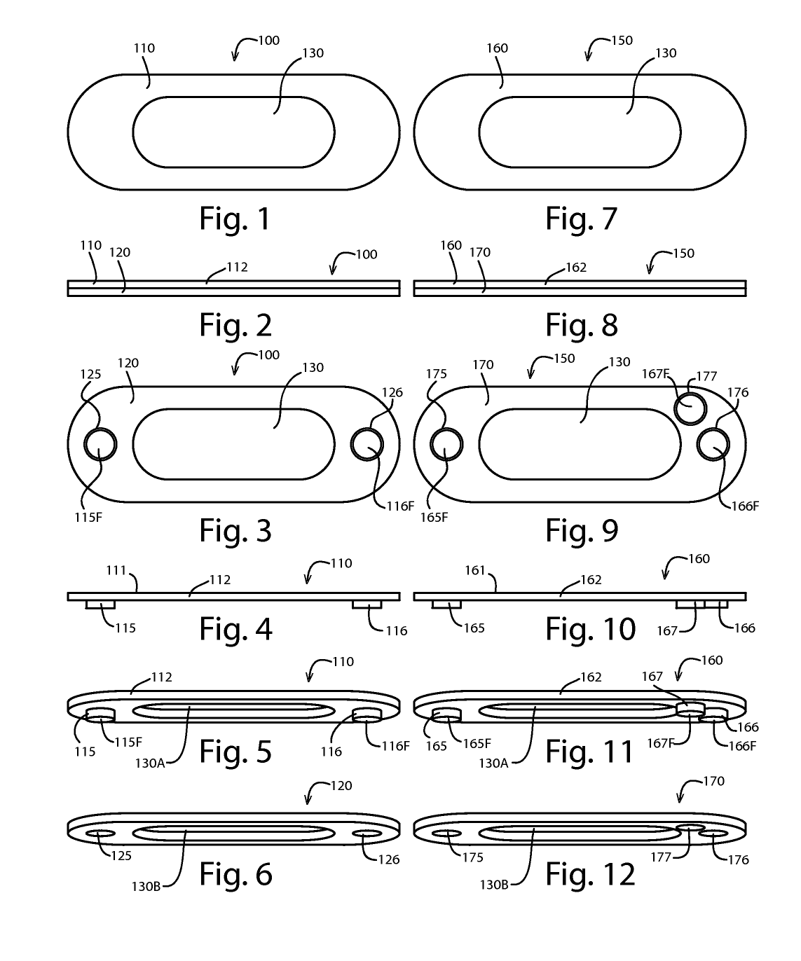

Please refer to FIG. 1 through FIG. 6, several views of a multitouch tool. The embodiment of a multitouch tool 100 has two layers, a conductive layer 110 and a nonconductive layer 120. The window 130 is a hole that extends through both layers.

The conductive layer 110 has a top surface 111, an outer edge 112, a plurality of conductive posts 115,116, and a window 130A. In some embodiments, the conductive layer 110 is monolithic; in some embodiments, the conductive layer 110 may be composed of one or more conductive materials in multiple parts, abutted against each other or joined together in any conventional manner to be mutually electrically conductive. The conductive layer 110 may be made of any solid conductive material, preferably nontoxic, such as a metal (aluminum, steel, copper, or other nontoxic metal that is a solid at temperatures below about 130 degrees Fahrenheit), a conductive polymer, a transparent conductor such as ITO, or a combination thereof. The conductive posts 115,116 may be of the same size or of different sizes, and may be of various geometric shapes (with each post optionally being different in shape), for example (but not limited to) circles, ovals, rectangles, crosses, and so on; the limiting consideration is that the conductive posts 115,116 must be capable of generating a “touch” when their proximal surfaces 115F,116F—while in electrically conductive coupling with the user—interact with the touchscreen's hardware, firmware, and software. If the individual capacitive touch patterns of post 115 and post 116 differ from one another, then the orientation of the multitouch tool may be tracked; if the individual touch patterns are the same, then the multitouch tool may be oriented in two ways, 180 degrees rotated, and the touchscreen will not be able to differentiate between the two. The proximal surfaces 115F,116F are substantially coplanar, so that both may interact simultaneously with the touchscreen device.

Note that although two posts are discussed, embodiments may have more than two posts. If these posts are arranged such that the touch pattern they form has rotational symmetry, then the orientation may only be trackable over an even smaller angle. For example, three identically shaped posts arranged in an equilateral triangle would result in a pattern whose relative angle to a datum line could only be determined across 120 degrees. In general, the angle would be determinable to 360/N degrees for N>1.

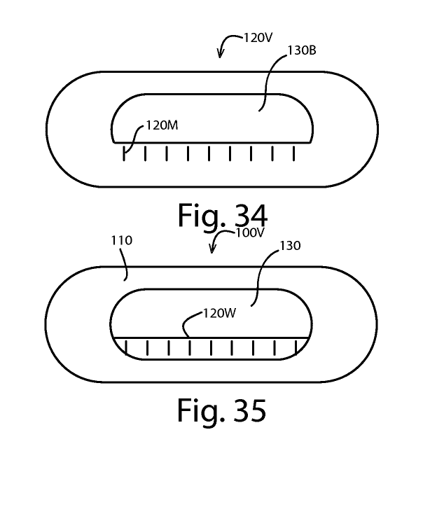

The nonconductive layer 120 may be made of a nonconductive polymer such as acrylic, polycarbonate, nylon, PTFE, ETFE, or a thermoplastic; it may also be made of other nonconductive materials such as wood, kevlar or carbon fiber coated with epoxy, or of a paper-based material; it may also be an air gap; it may also be a combination of nonconductive materials. The material may be chosen for utility or for fashion appearance or both. The material may be selected based on having a low coefficient of friction (less than 0.25) against glass and typical screen-protective plastic films. The nonconductive layer 120 comprises a plurality of holes 125,126 that correspond in size and location with the conductive posts 115,116 of the conductive layer 110. The nonconductive layer 120 may optionally comprise a window 130B. The window 130 is formed by the window 130A of the conductive layer 110 being placed adjacent to the window 130B of the nonconductive layer. In some embodiments, the window 130B corresponds in size, shape, and location with the window 130A of the conductive layer 110; in some embodiments, as shown in FIG. 34 and FIG. 35, the window 130B may be of a different size or shape or location from the window 130A of the conductive layer 110, optionally resulting in an area 120W of nonconductive layer 120 being viewable through the window 130A, this area being usable for printing onto it markings 120M such as reference marks, for example a scale, or other information such as a company logo or slogan, which would likewise be viewable through window 130A. An embodiment variation where window 130B is not congruent to window 130A is shown in FIG. 34 and FIG. 35. In such an embodiment, the nonconductive layer 120 or at least the area 120W may optionally be transparent; software running on the touchscreen device may display information through the window 130 and also underneath the area 120W so that it is visible against the markings 120M.

The conductive layer 110 and nonconductive layer 120 are assembled by placing the two layers against each other such that the conductive posts 115,116 fit through the holes 125,126. The fit may be a friction fit to hold the two layers 110,120 together, or the layers may be held together by an adhesive or by fasteners, or the nonconductive layer 120 may be molded over the conductive layer 110 so that the conductive layer 110 is overmolded or bonded to the nonconductive layer 120.

Portions of either nonconductive layer 120 or conductive layer 110 or both may optionally be marked with information, whether commercial (for example, a logo or trademark) or functional (for example, a scale or icon symbols) or decorative (line art, color imprints). These markings may be made in a visible location such as area 120W or may be hidden, for example as codes meant to make counterfeit detection easier.

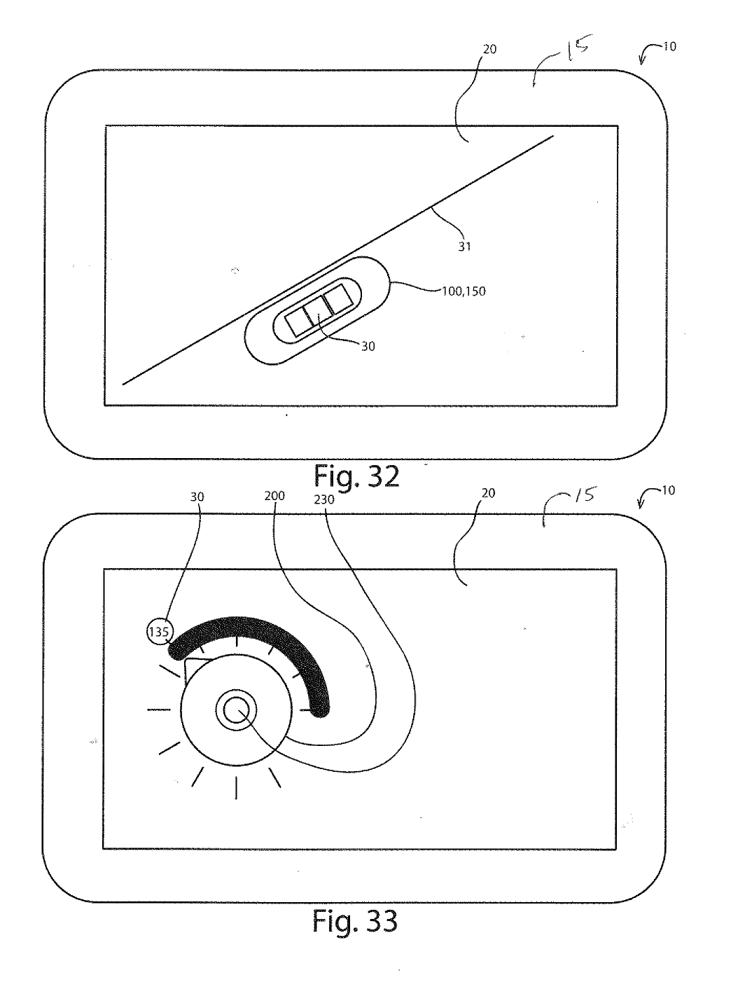

Referring to FIG. 32 in combination with the aforementioned figures, in use, the multitouch tool 100 is placed against the capacitive touchscreen of an electronic device such that the nonconductive layer 120 and the proximal surfaces 115F,116F of the conductive posts 115,116 are proximate to the touchscreen. The top surface 111 and edge 112 of the conductive layer may be touched by the user, at which time the proximate surfaces of the conductive posts 115,116 are electrically coupled to the user's body through the top surface 111 and/or edge 112, and the capacitive touchscreen of the electronic device will register “touches” at the screen locations proximate to the conductive posts 115,116. This occurs as the capacitance of the user's body affects charging in the capacitors of the capacitive touchscreen at the locations that are electrically coupled from the surfaces of the conductive posts 115,116 through the conductive posts 115,116 through the top surface 111 or edge 112 of the conductive layer 110 to the capacitance of the user's body. If the conductive posts 115,116 are symmetric, then the orientation of the multitouch tool 100 may be in either of two positions, a position where, from the user's viewpoint, a ray beginning from conductive post 115 and going through conductive post 116 is at an angle between zero to less than pi radians, or a position where a ray beginning from conductive post 116 and going through conductive post 115 is at an angle between zero to less than pi radians. The two positions are indistinguishable by the electronic device when the touches induced by conductive posts 115,116 cannot be distinguished in some way by the software on the touchscreen device.

Referring now to an embodiment of a multitouch tool as shown in FIG. 7 through FIG. 12, the multitouch tool 150 is largely similar in use and design to the multitouch tool 100 of FIG. 1 through FIG. 6. However, the multitouch tool 150 comprises a third conductive post 167 that is electrically conductive with the touchable surface 161 of the conductive layer 160. The conductive layer 160 has conductive posts 165,166,167. The nonconductive layer 170 has holes 175,176,177 through which the conductive posts 165,166,167 respectively fit.

The addition of a third post in an asymmetrical location allows the multitouch tool 150 to have its orientation tracked through 360 degrees. Unlike the multitouch tool 100, which (when each of its two posts have the same touch pattern) may be at either of two opposite orientations without the electronic device being able to detect which orientation, the asymmetric positions of the three conductive posts 165,166,167 allow the electronic device to know the location and orientation of the multitouch tool 150 at all angles.

As with the embodiment of FIG. 1 through FIG. 6, the present embodiment's conductive posts 165,166,167 have proximal surfaces 165F,166F,167F which are substantially coplanar so that they may all interact simultaneously and fully with the touchscreen device's multitouch capacitive sensing screen.

Referring now to FIG. 32 in combination with the aforementioned figures, in use, when either multitouch tool 100 or multitouch tool 150 is touched against a capacitive touchscreen of an electronic device, the electronic device may recognize the multitouch tool 100,150 by the sizes and positions of the conductive posts. The electronic device may then display a user interface control on the touchscreen display around and/or underneath the multitouch tool 100,150 so that the user interface control is visible either around the tool or through the window 130 of the multitouch tool 100,150, or both. The user may orient the multitouch tool 100,150 to a precise angle, and may use a finger or fingers, or a stylus, to tap or otherwise gesture on the user interface control through the window 130. Although a user could use multiple fingers to touch the touchscreen and trigger the same user interface control, and then manipulate the same user interface control with another finger or fingers, this is less accurate and less convenient than using a multitouch tool 100,150. By using the multitouch tool 100,150, users can focus on precisely placing and orienting the tool to get exactly the result that they desire, rather than having to shift their hands and fingers to precisely the right position and then further contort their hands to use more fingers (which may shift the fingertips they are using to generate touches, thereby affecting the precision of the on-screen interaction) to make a desired gesture against the user interface control. This frees the user's concentration to be focused upon the task that the user wishes to accomplish rather than upon precision finger contortions.

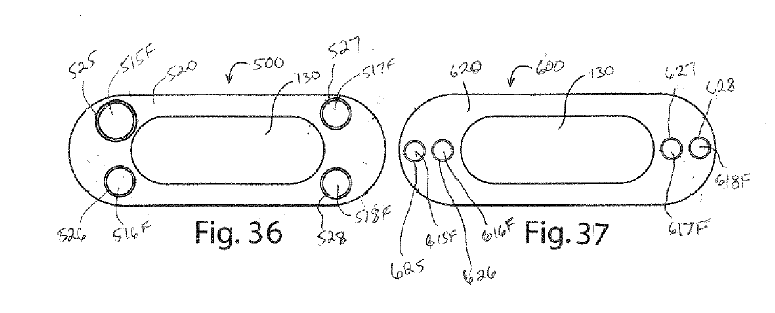

Referring momentarily to FIG. 36 and FIG. 37, bottom views of two embodiments of a multitouch tool: FIG. 36 shows a multitouch tool 500 having four conductive posts, the proximal surfaces 515F,516F,517F,518F of which are visible in the figure, arranged in a rectangular pattern. One or more posts (here, the post shown as 515F) may be sized differently so that it creates a larger touch on the touchscreen, thereby allowing software on the touchscreen device to determine orientation. The nonconductive layer 520 has a plurality of holes 525,526,527,528 to fit the posts. Similarly, FIG. 37 shows a multitouch tool 600 having a window 130 and four conductive posts, the proximal surfaces 615F,616F,617F,618F of which are shown; its nonconductive layer 620 likewise has a plurality of holes 625,626,627,628 sized and positioned to fit the posts. The arrangement of posts in these two embodiments allows tracking software on the touchscreen device to continue to track orientation even when a part of the multitouch tool 500,600 is off the touchscreen, for example resting on the bezel 15 (see FIG. 32 and FIG. 33) of the touchscreen of the electronic device where no capacitive sensing is performed. When sliding a multitouch tool 100,150,500,600 around a touchscreen, users may not distinguish between the active central portion of the touchscreen 20 (see FIG. 32 and FIG. 33) and the bezel 15 where the capacitive sensor does not reach, and when the user slides the multitouch tool so that a post is resting above the bezel, if only one touch continues to be detected, then orientation becomes impossible to determine. However, once a multitouch tool has been identified, by tracking the touches generated by the tool, when two or more touches remain on the touchscreen and continue to be tracked, then software can determine the orientation of the tool; however, in contrast to the multitouch tool 100, if a user slides the multitouch tool 500,600 past the edge of the touchscreen such that one of the posts no longer generates a touch, the remaining posts of multitouch tools 500,600 allow tracking to determine the orientation of the multitouch tools.

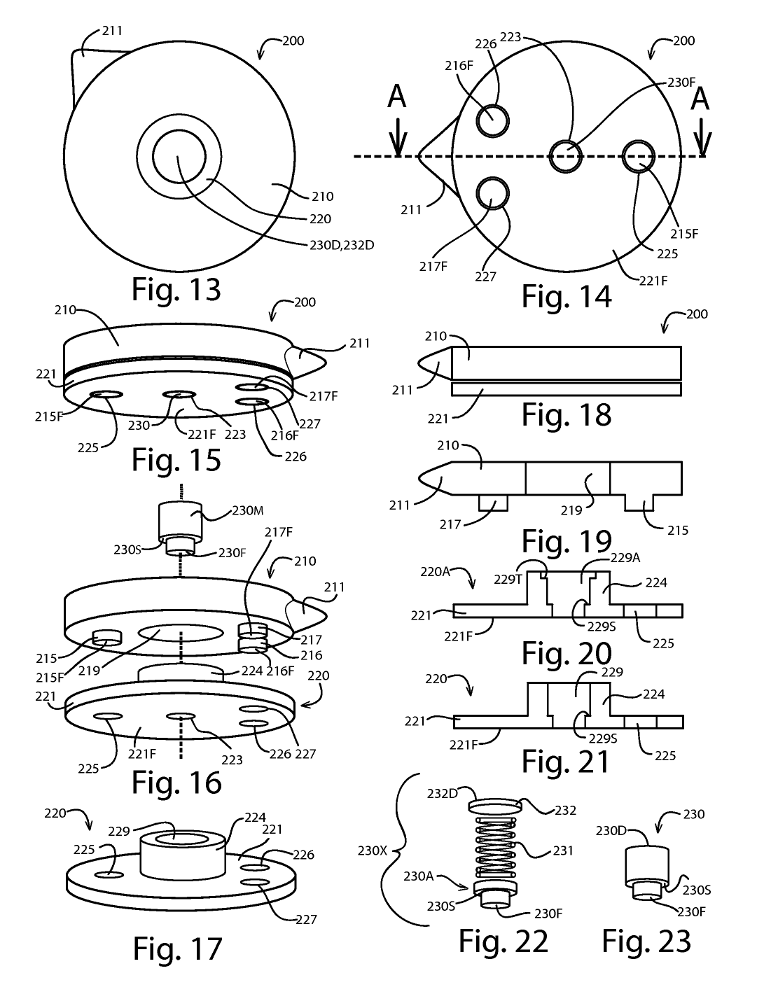

Referring now to FIG. 13 through FIG. 23, drawings from various views of an embodiment of a multitouch tool and its parts, the multitouch tool 200 has a conductive body 210, a nonconductive member 220, and a central conductive component 230. The central conductive component 230 is isolated from the conductive body 210 by the nonconductive member 220, and so the capacitance of the central conductive component 230 can be activated separately from the capacitance of the conductive body 210. The conductive body 210 may optionally be made large enough to be detected by the capacitive touchscreen without the user touching the conductive body 210.

The conductive body 210 has a plurality of conductive posts 215,216,217 protruding from it. The proximal surfaces 215F,216F,217F of the conductive posts 215,216,217 are substantially coplanar, so that they may all interact simultaneously and substantially completely with a capacitive touchscreen when the multitouch tool 200 is placed upon the capacitive touchscreen of an electronic device. The arrangement of the conductive posts 215,216,217 may be such that an orientation of the multitouch tool 200 may be determined by analyzing the touch pattern. In some embodiments, the posts are arranged as the vertices of an isosceles triangle.

The conductive body 210 has an orientation indicator 211. This indicator 211 may be a bulbous nose as shown in the figures, or may be an etched or engraved or painted or anodized dot, or may be some other physical indicia; its purpose is to give the user a visual and/or tactile indication of the orientation of the multitouch tool 200, much as the “north” on a compass rose or the twelve-o'clock jewel on a designer watch face does, or the oval shape of a typical computer mouse does.

The directional relationship between the indicator 211 and the touch pattern of the multitouch tool 200 is fixed, and is known to the software (see below) on the touchscreen device, allowing the software to relate the position and orientation of the multitouch tool 200 to the user.

For example, when the conductive posts are arranged as the vertices of an isosceles triangle, as shown in FIG. 14, the touch pattern generated thereby allows a touchscreen device to determine an axis such as line A-A and to determine an orientation as being the direction of indicator 211, by straightforward geometric analysis of the three touches that make up the touch pattern.

The nonconductive body 220 has a face 221, a column 224, a well 229 in the column 224, and a plurality of holes 225,226,227. The face 221 has a proximal surface 221F that is substantially planar. In some embodiments, when assembled with the conductive body 210 the proximal surface 221F may be substantially coplanar with the faces of the conductive posts 215F,216F,217F. In some embodiments, the faces of the conductive posts 215F,216F,217F may be slightly recessed below the surface of the proximal surface 221F of the nonconductive body, to provide for scratch protection for the touchscreen or touchpad against which the multitouch tool 200 might be placed during use. The holes 225,226,227 are sized and positioned to receive the conductive posts 215,216,217 of the conductive body 210. The column 224 has a well 229 or 229A which terminates in a hole 223. The central conductive component 230 or assembly 230X fits within the well and its proximal surface 230F emerges through the hole 223 such that proximal surface 230F is substantially coplanar with the proximal surface 221F of the nonconductive body and with the faces of the conductive posts 215F,216F,217F. The nonconductive body 220 electrically isolates the central conductive component 230 from the conductive body 210.

The central conductive component 230 may be monolithic, as shown in FIG. 23, or may be made of multiple subcomponents, such as assembly 230X shown in FIG. 22. The central conductive component 230 is sized and shaped to fit within the well 229 in the column 224 of the nonconductive body 220. By itself, the central conductive component 230 has insufficient capacitance to register a touch on a touchscreen display, but when touched by the user, the added capacitance of the user's body, capacitively coupled to the screen via the central conductive component 230, registers as a touch.

When using a monolithic embodiment of the central conductive component 230 such as that of FIG. 23, a well 229 having a ledge 229S such as shown in FIG. 21 may be formed in the nonconductive body 220. This prevents user-applied pressure to the distal surface of the central conductive component 230 from being transferred against the touchscreen, and the ledge 229S serves to position the proximal surface 230F so that it is substantially coplanar with the other conductive posts' faces 215F,216F,217F and the proximal surface 221F of the nonconductive body 220.

When using a non-monolithic embodiment of the central conductive component such as assembly 230X shown in FIG. 22, multiple ledges 229S,229T as shown in FIG. 20 may be used to retain and position the multiple subcomponents such as touch disk 232, conductive spring 231, and central conductive component 230A within the well 229A. In this embodiment, the central conductive component 230A is retained by the ledge 229S, and is electrically coupled to touch disk 232 by coil spring 231. The touch disk 232 fits snugly into the top of well 229A and abuts ledge 229T. All three of these components—touch disk 232, coil spring 231, and central conductive component 230A—are made of conductive materials, which may differ from each other. The proximal surface 230F of the central conductive component 230A is held approximately coplanar with proximal surface 221F of the nonconductive body 220.

A distal surface 230D of the central conductive component 230 or distal surface 232D of the touch disk 232 is located on the top of the multitouch tool 200. The user touches this distal surface 230D,232D in order to change the touch pattern registering on the touchscreen device, thereby interacting with the software on the device.

In use, the conductive body 210 may have sufficient capacitance to produce a touch pattern on the touchscreen or touchpad on its own, or it may require contact with a human user in order to have sufficient capacitance to register on the touchscreen or touchpad.

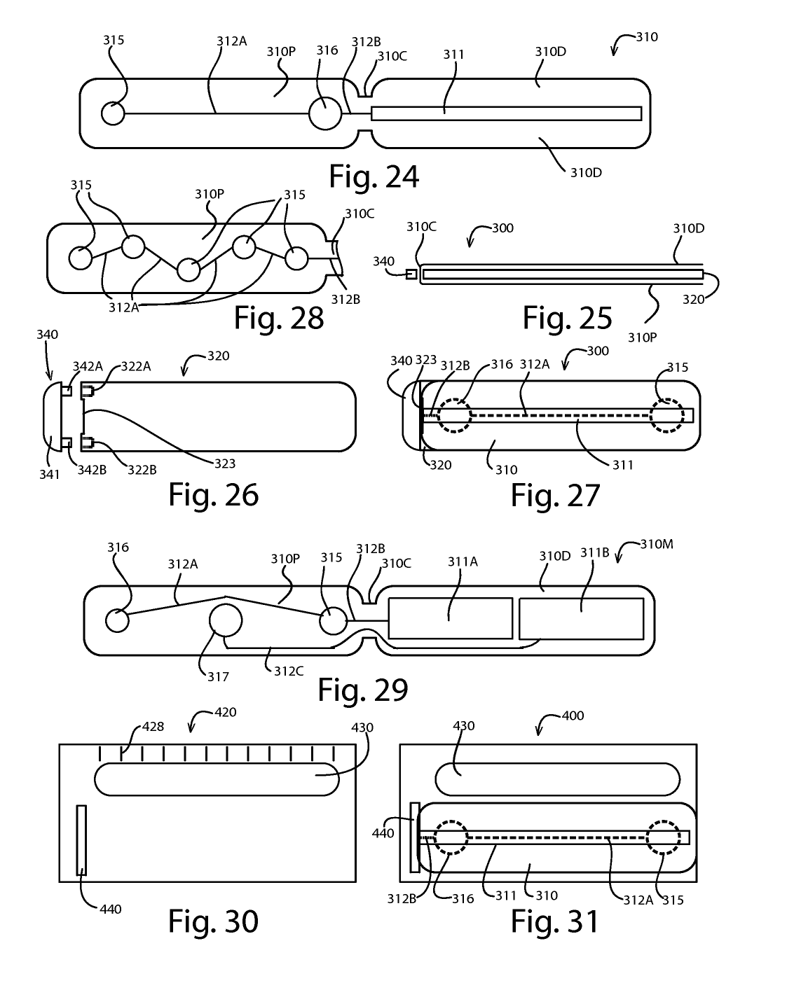

Referring now to FIG. 24 through FIG. 28, another embodiment of a multitouch tool 300 is shown.

The multitouch tool 300 has a nonconductive body 320 which is wrapped with a substrate 310 having conductive regions and connecting paths formed on said substrate 310.

The substrate 310 has a distal segment 310D, a connecting segment 310C, and a proximal segment 310P. The substrate has two surfaces, one of which will be arranged to be on the outside when wrapped around the nonconductive body 320; this is arbitrarily designated the outside face 310F. A pattern of electrically conductive regions and interconnecting paths is formed on the outside face 310F of the substrate 310, for example in a user contact region 311 electrically connected to a plurality of conductive regions 315,316 by conductive path 312B. The plurality of regions 315,316 are electrically coupled by conductive path 312A; the regions 315,316 may be the same size and shape, as shown in FIG. 27, or of different sizes and/or shapes as shown in FIG. 24. In some embodiments, conductive paths 312A,312B are narrowly formed so that they do not provide enough capacitive coupling to a touchscreen to register as a touch on a touchscreen device.

Optionally, an endcap 340 protects the substrate 310 and the wrapped section of conductive path 312B formed thereon from damage and excessive wear at the vulnerable bend, which is wrapped around the nonconductive body at clearance cut 323. A multitouch tool may be made, or used, without such an endcap, however. Although shown as having two pins 342A,342B which are friction-fit into holes 322A,322B (shown in outline) in the nonconductive body 320, the endcap 340 may be attached by other means, such as adhesives, welding (ultrasonic, chemical, heat, etc.), or other conventional techniques known in the art.

The nonconductive body 320 may be of any shape, whether functional and/or decorative, such as oblong, triangular, circular, or shaped like a Christmas tree or cartoon character. There may be any pattern of conductive elements on the proximal surface 310P. FIG. 28 shows a pattern with five conductive regions; most capacitive touchscreen or touchpad solutions can track many touches at the same time, for example, the APPLE iPAD can track up to ten simultaneous touches. The number of regions in the plurality of regions 315,316 is limited only by the touchscreen hardware of the device(s) with which the multitouch tool is intended to be used, possibly reduced if software is intended to track one or more user touches in addition to the touch pattern of the multitouch tool 300.

FIG. 29 shows an embodiment of a substrate 310M for a multitouch tool on which a plurality of separate conductive regions, traces, and user contact regions are formed. User contact region 311A is electrically coupled to regions 315 and 316 through traces 312A and 312B, while user contact region 311B is electrically coupled to region 317 via trace 312C. Accordingly, the two touch patterns may be activated separately, or both together, depending on which user contact region(s) 311A,311B the user touches at any given time.

FIG. 30 and FIG. 31 show an alternative embodiment in which a nonconductive body 420 is wrapped with the same substrate 310 having conductive paths and regions formed thereon. The nonconductive body has a window 430. The substrate 310 is wrapped through a slot 440 in the nonconductive body 420, providing protection to the conductive path 312B where it wraps around the nonconductive body 420 and is most vulnerable to damage. As shown in FIG. 30, the nonconductive body 420 may have a pattern 428 formed upon it, in this case a series of tick marks that may be used as a ruler, a volume-setting guide (zero to eleven in the example as shown), or for any other purpose that an app designer may choose.

Referring now to FIG. 32, a top view of an embodiment of a multitouch tool in use on a touchscreen device, the multitouch tool 100 or multitouch tool 150 or multitouch tool 500 or multitouch tool 600 has been sensed by the device 10, and in response a user interface is displayed on the screen 20. The device 10 is programmed with data specifying the multitouch tool's shape, including the position of the window 130 and relative location of a primary edge 112A, and displays a user interface 30 positioned appropriately within the window 130 by the device detecting the locations and sizes of the touches that make up the touch pattern. Bezel 15 of the touchscreen device 10 is an inactive area surrounding the active region of the touchscreen 20 which senses touches and displays data. In this example, the device also displays a line 31 oriented parallel to the tool 100,150 and drawn along the primary edge 112A of the tool 100,150, as determined by the tool orientation, the orientation being determined by the touch pattern. The user may interact with the user interface 30 by touching a fingertip to the icons of the user interface 30 through the window 130 of the tool 100,150.

The multitouch tool 100,150,500,600 can be used for more than just lines, however. It may, for example orient a grid, with grid spacing set by the user adjusting a virtual scrollbar within the window 130, or may generate an arc or another geometric figure with the figure's size set through adjusting said virtual scrollbar; the arc's start and end points may then be set using a fingertip to draw on the screen. Note that the multitouch tools 300 and 400 can be used in the same manners.

Uses for such interactions may include their use in drawing programs for CAD diagrams or geometric figures, flight planning or other route planning software, GIS or other mapping software, or games, among other applications.

FIG. 33 shows a multitouch tool 200 being used as a rotary control on a touchscreen device 10 having a bezel 15 and touchscreen 20 to set an angle. Although the embodiments of multitouch tools 100,150 could be used similarly, the multitouch tool 200 is shaped to conform to users' experiences with rotary knobs, such as having a mostly round shape plus an orientation indicator 211. Uses may include, for example without limitation, setting an angle in a CAD program, setting a volume for a music program, or use with a virtual turntable for “scratching” a virtual vinyl record with the multitouch tool 200 being used to twist the virtual record while the user uses a separate finger or stylus to virtually scratch the virtual vinyl. The central conductive component 230 may, for example without limitation, be used to lock and unlock a setting, or to indicate selection of the setting to the user interface 30, or for other purposes a developer may envision.

We claim as our invention:

1. A multitouch tool, comprising:
an electrically conductive layer comprising a first surface, a second surface, and a window;
a plurality of posts, each post being electrically conductive, each post having a proximal surface, each post electrically coupled to the first surface of the electrically conductive layer;
an electrically nonconductive layer comprising a proximal surface, a window, and a plurality of holes corresponding in size and location to the plurality of posts, the electrically nonconductive layer being disposed against the first surface of the electrically conductive layer such that the plurality of posts pass through the plurality of holes;
where the window of the electrically conductive layer overlaps the window of the electrically nonconductive layer.

2. The multitouch tool of claim 1 where the proximal surfaces of the plurality of posts are approximately coplanar.

3. The multitouch tool of claim 2 where the proximal surface of the electrically nonconductive layer is approximately coplanar with the proximal surfaces of the plurality of posts.

4. The multitouch tool of claim 1, where the plurality of posts consists of four posts, and where the four posts are arranged in a rectangle.

5. The multitouch tool of claim 1, where the window of the electrically nonconductive layer is congruent to the window of the electrically conductive layer.

6. A multitouch tool, comprising:
a nonconductive substrate,
a conductive trace formed on a first surface of the substrate,
an adhesive on a second surface of the substrate,
the conductive trace comprising a plurality of conductive regions and a user contact region;
a nonconductive body,
the substrate adhered to the nonconductive body by the adhesive.

7. The multitouch tool of claim 6 where the conductive trace is a first conductive trace, comprising a second conductive trace formed on the first surface, the second conductive trace being electrically isolated from the first conductive trace, the second conductive trace comprising a second plurality of contact regions and a second user contact region.

8. The multitouch tool of claim 6 where the nonconductive body comprises a window.

9. The multitouch tool of claim 6 where the nonconductive body comprises a slot, and the substrate passes through the slot.

10. The multitouch tool of claim 6 wherein the nonconductive body comprises printed information upon a surface of the nonconductive body.

11. A multitouch tool, comprising:
an electrically conductive body,
a plurality of posts, each post being electrically conductive, each post having a proximal surface, each post electrically coupled to the body,
a nonconductive member comprising a proximal surface and a plurality of holes, the plurality of holes corresponding in size and location to the plurality of posts,
a central conductive component, the central conductive component being isolated from the conductive body by the nonconductive member, the central conductive component having a proximal surface,
the proximal surfaces of the plurality of posts, the proximal surface of the central conductive component, and the proximal surface of the nonconductive member being substantially coplanar,
the conductive body having an orientation indicator.

12. The multitouch tool of claim 11, where the central conductive body is monolithic.

13. The multitouch tool of claim 11, where the conductive body is substantially circular.
